(19) United States
(12) Patent Application Publication
(10) Pub. No.: US 2009/0018745 A1
(43) Pub. Date: Jan. 15, 2009

(54) SYSTEM AND METHOD FOR OPERATING A MACHINE

(75) Inventors: Eko A. Prasetiawan, Holly Springs, NC (US); Satyaki Guha, Apex, NC (US)

Correspondence Address: Caterpillar Inc.;Intellectual Property Dept., AH 9510, 100 N.E. Adams Street, PEORIA, IL, 61629-9510, US

(73) Assignee: CATERPILLAR INC, Peoria, IL (US)

(21) Appl. No.: 11/967,399

(22) Filed: Dec. 31, 2007

Related U.S. Application Data
(60) Provisional application No. 60/883,023, filed on Dec. 31, 2006.

(51) Int. Cl. G06F 19/00; B62D 49/00

(52) U.S. Cl. 701/99; 180/323

(57) ABSTRACT

A machine is provided. The machine includes a body, an engine, a seat assembly, an electronic control module, a first throttle, and a second throttle. The engine is mounted within the body and powers the machine. The seat assembly is rotatably mounted to the body and moveable between a first position and a second position. The electronic control module is in electrical communication with the engine and the seat assembly. The first throttle is in electrical communication with the electronic control module and operable to control engine speed with a first throttle command when the seat assembly is in the first position. The second throttle is in electrical communication with the electronic control module and operable to control engine speed with a second throttle command when the seat assembly is in the second position and the second throttle command is greater than the first throttle command.

### CLAIM FOR PRIORITY

The present application claims priority from U.S. Provisional Application Ser. No. 60/883,023, filed Dec. 31, 2006, which is fully incorporated herein.

### TECHNICAL FIELD

The present disclosure relates generally to a system and method for operating a machine, and more particularly, to a system and method for selecting an operator input device for a backhoe loader or another machine with a reorientable seat assembly.

### BACKGROUND

Machines, such as skid steer loaders, multi terrain loaders, backhoe loaders, agricultural tractors, track-type tractors, articulated trucks, wheel loaders, and other types of construction, mining, or agricultural machinery are used for a variety of tasks requiring operator control. Typically, an operator controls these machines through an interface. For machines having a fixed operator orientation, only a single set of input devices are needed for various machine controls, such as for the throttle control or a transmission control. As a result, the controls for such operator interfaces may be optimized for available engine power, machine speed, sensitivity, and fuel economy.

However, in a machine having a reorientable operator interface controlling different operations, such as a backhoe loader, an operator may require more input devices, such as one operable in a forward direction and another operable in a reverse direction. Determining which input device to use and optimizing the controls for engine power, machine speed, and fuel economy proves problematic.

The present disclosure is directed to overcome one or more of the problems as set forth above.

### SUMMARY

In one aspect of the present disclosure, a machine is provided. The machine includes a body, an engine, a seat assembly, an electronic control module, a first throttle, and a second throttle. The engine is mounted within the body and powers the machine. The seat assembly is rotatably mounted to the body and moveable between a first position and a second position. The electronic control module is in electrical communication with the engine and the seat assembly. The first throttle is in electrical communication with the electronic control module and operable to control engine speed with a first throttle command when the seat assembly is in the first position. The second throttle is in electrical communication with the electronic control module and operable to control engine speed with a second throttle command when the seat assembly is in the second position and the second throttle command is greater than the first throttle command.

In another aspect of the present disclosure, a control system for use in a machine is provided. The machine has a seat assembly moveable between a first position and a second position. The control system includes a seat assembly position sensor mounted to the seat assembly, an electronic control module, a first throttle, and a second throttle. The electronic control module is in electrical communication with the seat assembly position sensor and includes an engine speed control algorithm to determine an engine speed. The first throttle is in electrical communication with the electronic control module and sends a first throttle command. The second throttle is in electrical communication with the electronic control module and sends a second throttle command. The engine speed control algorithm uses the first throttle command to determine the engine speed when the electronic control module determines the seat assembly is in a first position, and the engine speed control module uses the second throttle command to determine the engine speed when the electronic control module determines the seat assembly is in a second position and the second throttle command is greater than the first throttle command.

A third aspect of the present disclosure includes a method of operating a machine. The machine has an engine, an electronic control module in electrical communication with the engine, a seat assembly in electrical communication with the electronic control module, and a first and a second throttle in electrical communication with the electronic control module. The method includes the step of operating the engine with a first throttle command from the first throttle when the seat assembly is in a first position. The method also includes the step of operating the engine with a second throttle command from the second throttle when the seat assembly is in a second position and the second throttle command is greater than the first throttle command.

### BRIEF DESCRIPTION OF THE DRAWINGS

FIG. 1 is a side view of a backhoe loader including a seat assembly in a loader position;

FIG. 2 is a side view of the backhoe loader including the seat assembly in a backhoe position;

FIG. 3. is a side view of the backhoe loader including the seat assembly in a middle position;

FIG. 4 is a table showing the desired engine speed corresponding to a dial setting for a manual throttle control; and

FIG. 5 is a schematic showing the operator input control strategy for a throttle of the backhoe loader.

### DETAILED DESCRIPTION

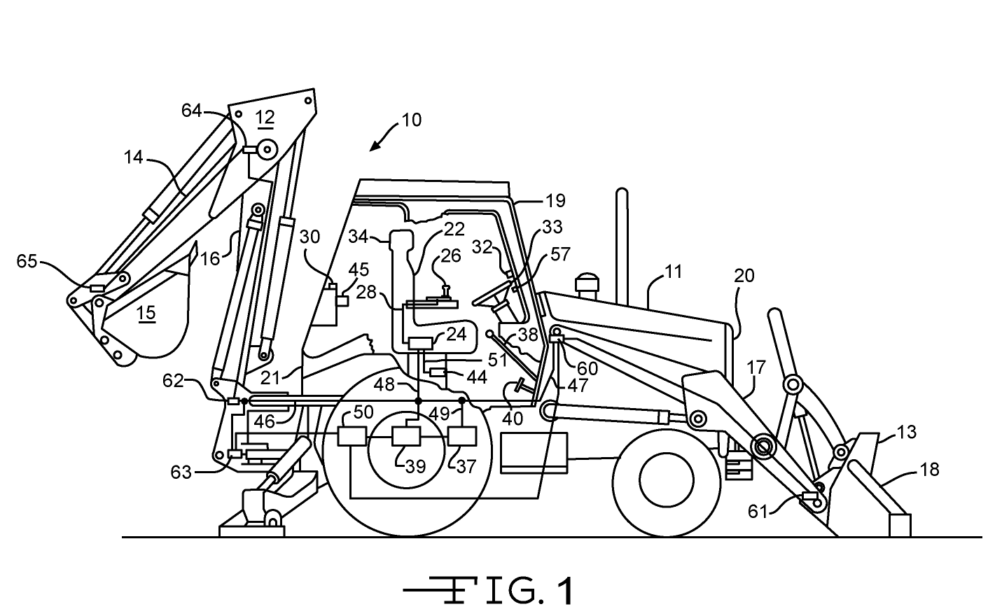

Referring to FIGS. 1-3, there are shown side views of a machine 10, which in the illustrated example is backhoe loader 10. Those skilled in the art will appreciate that the present disclosure contemplates other machines such as pavers and/or graders, where different aspects of the machine are operated from different seat positions. Thus, although the machine 10 is illustrated as a backhoe loader 10, it should be appreciated that the present disclosure contemplates other types of machines. Those skilled in the art will appreciate that the term backhoe includes any machine with at least one implement used for stationary digging. For instance, the present disclosure could be applied to a backhoe dozer having a backhoe used for stationary digging attached to a rear side of the machine body and a dozer attached to a front side of the machine body. Further, the present disclosure may apply to a backhoe in which some other tool has been substituted in place of the backhoe bucket, such as a ram.

The backhoe loader 10 includes a machine body 11. Attached to a rear side 21 of the machine body 11 is a set of equipment, preferably a backhoe 12 generally used for stationary digging. Attached to a front side 20 of the machine body 11 is preferably a second set of equipment, shown as a loader 13 generally used for shoveling. The backhoe 12 includes a boom 16 that is moveably attached to the machine body 11, and can be moved upward and downward and swung left and right about a vertical axis. A stick 14 is moveably attached to the boom 16 and can be moved inward and outward. The backhoe 12 also includes a material engaging member, shown as a backhoe bucket 15 that is moveably attached to the stick 14. The backhoe bucket 15 can be curled in order to dig, and can be uncurled outward in order to dump material. The loader 13 includes a pair of arms 17 movably attached to the front side 20 of the machine body 11. The pair of arms 17 can be moved upward and downward in order to lift and lower a material engaging member, shown as a loader bucket 18. The loader bucket 18 is moveably attached to the pair of arms 17 and can be raised and lowered about a horizontal axis. There is at least one electronically controlled actuator attached to at least one hydraulic cylinder controlling the movement of each aspect of both the backhoe 12 and the loader 13, although mechanically or pressure controlled actuators may also be used. The illustrated backhoe loader 10 includes a loader arms actuator 60, a loader bucket actuator 61, a boom vertical movement actuator 62, a boom swing actuator 63, a stick actuator 64, and a backhoe bucket actuator 65.

An engine 39, which is attached to the machine body 11, is coupled to a transmission 37 in order to provide power for translational movement of the backhoe loader 10, and is coupled to at least one hydraulic pump 50 in order to provide power for operation of the backhoe 12 and the loader 13. The engine 39 may be any power source such as, for example, a diesel engine, a gasoline engine, a gaseous fuel driven engine, or any other engine known in the art. It is contemplated that the engine 39 may alternately include another source of power such as a fuel cell, a power storage device, an electric or hydraulic motor, and/or another source of power known in the art. It is also contemplated that the engine 39 may be operatively connected to the transmission 37 and the pump 50 by any suitable manner known in the art, such as, for example, gearing, a countershaft, and/or a belt. The engine 39 powers the hydraulic pump 50, which supplies pressurized hydraulic fluid to the hydraulic cylinders via the actuators 60, 61, 62, 63, 64, and 65. A throttle valve (not shown) controls the flow of fuel from the fuel pump to fuel injectors attached to the engine 39, and thereby controls the engine speed.

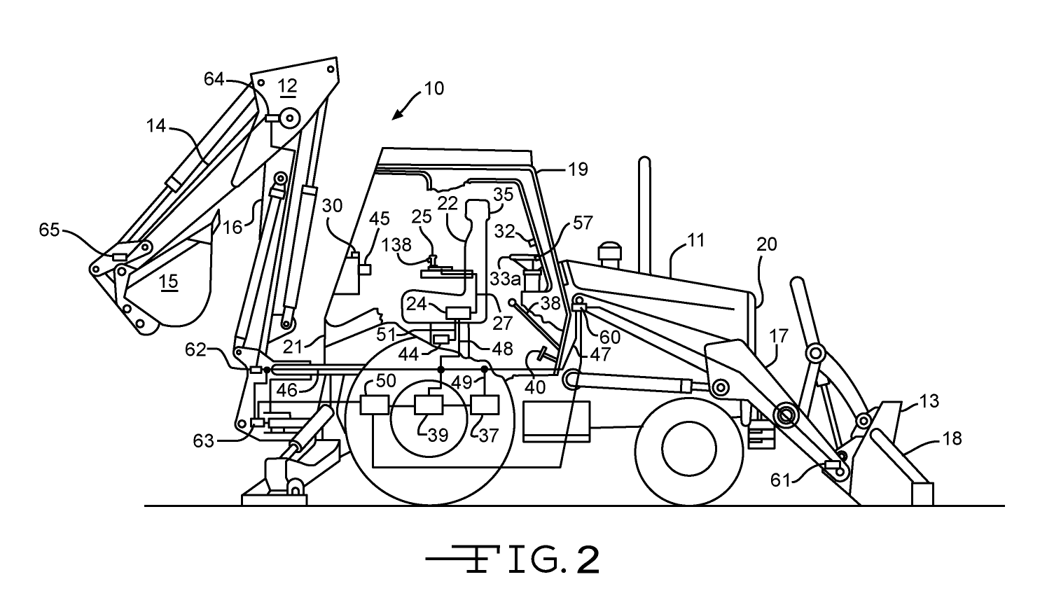

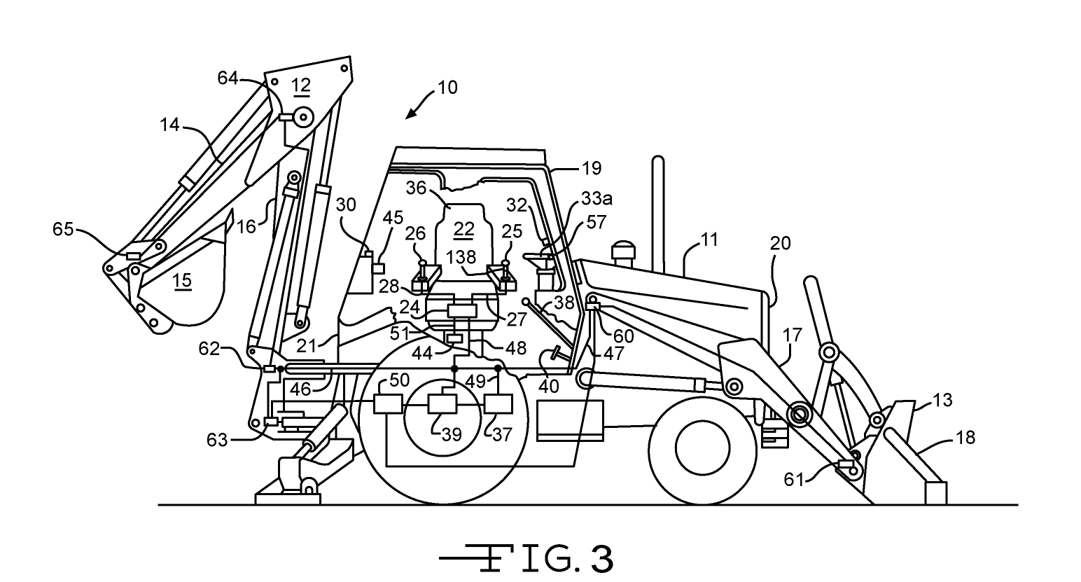

The backhoe loader 10 also includes a cab 19 in which a seat assembly 22 is rotatably mounted to the machine body 11. Although the seat assembly 22 may include translational movement, the seat assembly 22 rotates about a vertical axis between a forward facing position illustrated as a loader position 34 in FIG. 1, a rearward facing position illustrated as a backhoe position 35 in FIG. 2, and a middle facing position 36 in FIG. 3. The loader position 34 is preferably a latched position, and is separated by approximately 180 degrees from the backhoe position 35, also preferably a latched position. The middle facing position 36 is preferably an unlatched position between the loader position 34 and the backhoe position 35. When the seat assembly 22 is in the loader position 34, the loader 13 is preferably enabled. When the seat assembly 22 is in at least one of the backhoe position 35 and the middle facing position 36, the backhoe 12 is preferably enabled.

A seat position sensor 44 is positioned within the seat assembly 22. The seat assembly is in communication with an electronic control module 24 through a seat communication line 51.

The electronic control module or ECM 24 may include one or more microprocessors, a memory, a data storage device, a communications hub, and/or other components known in the art. It is contemplated that the ECM 24 may be further configured to receive additional inputs (not shown) indicative of various operating parameters of the machine 10 and or additional components, such as, for example, temperature sensors, positions sensors, and/or any other parameter known in the art. It is also contemplated that the ECM 24 may be preprogrammed with parameters and/or constants indicative of and/or relating to the machine 10. It is also contemplated that the ECM 24 may receive and deliver signals via one or more communication lines (not shown) as is conventional in the art. It is further contemplated that the received and delivered signals may be any known signal format, such as, for example, a current or a voltage level. Although it should be appreciated that the electronic control module 24 could be located within the machine body 11 or at any position within the seat assembly 22, the electronic control module 24 is illustrated as embedded in a seat of the seat assembly 22.

In addition, while implement controllers could be attached to the machine body 11, a first joystick 25 and a second joystick 26 are preferably attached to a right and left side of the seat assembly 22. Although the joysticks 25 and 26 could be mechanically operably coupled to the loader 13 and the backhoe 12, the first joystick 25 and the second joystick 26 are preferably in communication with the electronic control module 24 via a first communication line 27 and a second communication line 28, respectively. An engine speed reduction controller (not shown) may be mounted as a button attached to the second joystick 26, and is moveable between an on position and an off position, and is in communication with the ECM 24 via the second communication line 28. The ECM 24 is preferably in communication with the loader arms actuator 60 and the loader bucket actuator 61 via a loader communication line(s) 47, and is in communication with the boom vertical movement actuator 62, the boom swing actuator 63, the stick actuator 64, and the backhoe bucket actuator 65 via a backhoe communication line(s) 46. The ECM 24 is in communication with the engine 39 and the transmission 37 via an engine communication line 48 and a transmission communication line 49, respectively. Although the present disclosure is illustrated as including only one electronic control module 24, it should be appreciated that there could be any number of electronic control modules, including but not limited to, five additional electronic control modules, one to control each of the engine, the transmission 37, the backhoe 12, the loader 13, and the throttle valve 53, and each being in communication with the ECM 24.

A steering wheel 33 is preferably attached to the machine body 11 such that when the seat assembly 22 is in the loader position 34, the operator can use the steering wheel 33. The steering wheel 33 can be stowed for operation of the backhoe loader 10 when the seat assembly 22 is in the backhoe position 35 or the middle facing position 36.

Although it should be appreciated that a first transmission controller 38 could be attached to rotate with the seat assembly 22, the first transmission controller 38 is illustrated as attached to the machine body 11 such that when the seat assembly 22 is in the loader position 34, the operator can manipulate the first transmission controller 38. A second transmission controller 138 may also be provided. The second transmission controller 138 may include a column-mounted shifter, a joystick rocker switch, or a gear selector and used to control the transmission status. As shown in FIGS. 2-3, the second transmission controller 138 may be mounted to the left joystick 25 as a joystick rocker switch, selectable between forward, reverse, and neutral transmission states. The transmission 37 may be a mechanical or electrical variable-speed drive, a gear-type transmission, a hydrostatic transmission, or any other transmission known in the art. The first transmission controller 38 and the second transmission controller 138 operatively shift the transmission 37 between forward, neutral, and reverse gears.

An engine speed reduction-disabling switch 30 is preferably attached to a console on the rear side 21 of the machine body 11, and is moveable between an activated position and a de-activated position.

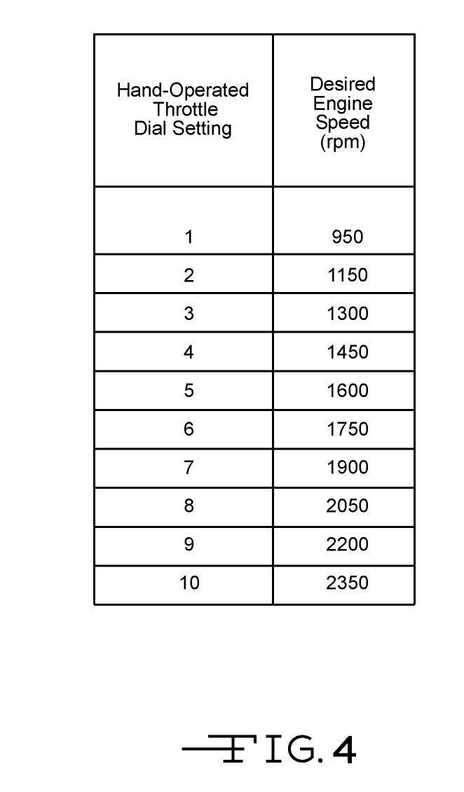

Although it should be appreciated that there could be only one manual throttle controller, the present disclosure is illustrated as including two throttle controllers 40, 45. A first throttle controller, preferably a hand operated throttle controller 45, is preferably moveably attached to the console on the rear side 21 of the machine body 11. The operator can control the engine speed when the transmission 37 is not engaged by manipulating the hand-operated throttle controller 45. The hand operated throttle controller 45 may be a ten-position rotary switch that is moveable between various throttle settings, including but not limited to, an increased throttle setting backhoe operation and a predetermined low idle engine setting. Each throttle setting of the hand-operated throttle controller 45 corresponds with a desired engine speed, as shown in FIG. 4. A predetermined low idle speed throttle setting could be less than 1000 rpm. Although the predetermined low idle speed and the increased engine speed may vary depending on the size and type of the backhoe, those skilled in the art should appreciate that the predetermined low idle speed is an engine speed that provides the minimum power required to maintain idling of the backhoe loader 10, and the increased engine speed is an engine speed that provides sufficient power to operate the hydraulically-controlled backhoe 12.

A second throttle controller, preferably a foot pedal 40, is also attached to the machine body 11, although it should be appreciated that the foot pedal 40 could be attached to the seat assembly 22 at a point that the operator can reach when operating the loader 13. The foot pedal 40 allows the operator to control the machine speed when driving the backhoe loader 10 and, at least in part, when operating the loader 13. The throttle controllers 40, 45 and the transmission controller 38 are coupled to ECM 24 and the transmission 37, respectively. It should be appreciated that the throttle controllers 40, 45 and the transmission controller 38 could be mechanically operably coupled or electronically operably coupled via the electronic control module 24 to the to the fuel system and the transmission 37, respectively.

### INDUSTRIAL APPLICABILITY

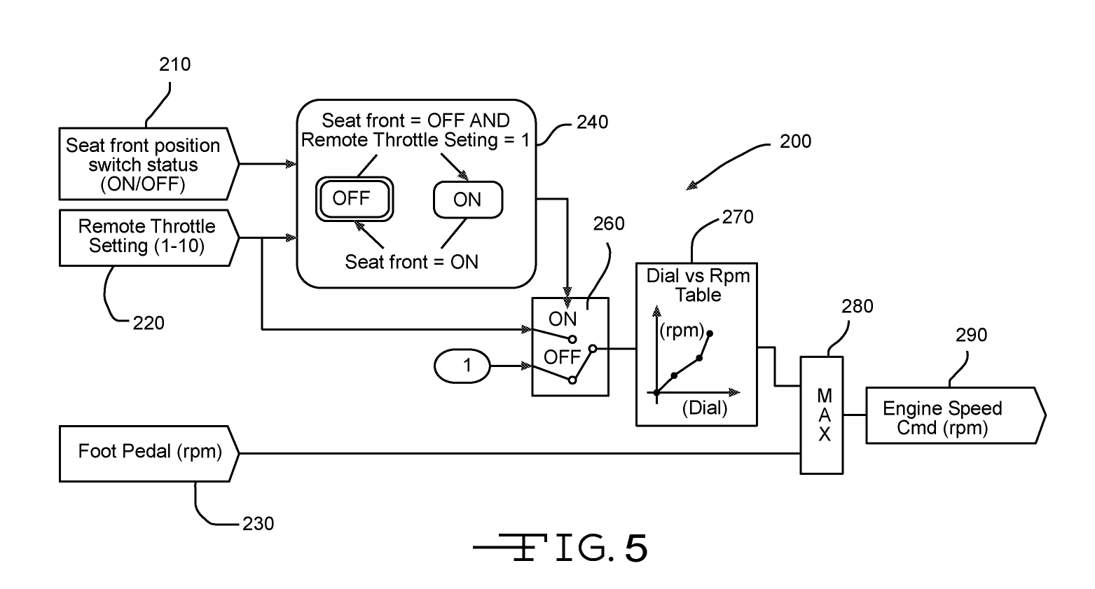

In operation, an operator control strategy 200 for a backhoe loader is provided in FIG. 5. As seen in FIG. 5, the strategy 200 provides an engine speed command from the ECM 24 to the engine 39 based on the status of the first throttle controller 45, the second throttle controller 40, and the seat position sensor 44. The strategy 200 first inputs the status of the seat position sensor 44 in step 210, setting a flag to ON if the seat assembly 22 is in a forward facing position 34. The strategy 200 also inputs the setting of the first throttle controller 45 in step 220 and the setting of the second throttle controller 40 in step 230. Step 240 is set to OFF if the seat assembly 22 is in a forward facing position 34 and to ON if the seat assembly 22 is not in the forward facing position 34 and the first throttle controller is set to the lowest setting or “1”. Step 260 looks at the output of step 240, and if set to ON from step 240, provides step 270 with the setting from the first throttle controller 45. Step 270 looks up the desired engine speed based on the setting of the first throttle controller 45, as tabulated in FIG. 4. Step 280 compares the output of step 270 with the commanded speed of the second throttle controller 40 and provides step 290 with the greater of the two values. Step 290 provides the output of step 280 as the commanded engine speed in revolutions per minute.

The strategy 200 resolves the engine speed commands between the first and second throttle controllers 45, 40 based on the application of the machine 10, which is determined by the seat position sensor 44. The ECM 24 accepts a commanded speed from either the remote throttle or first throttle controller 45 or the foot pedal or second throttle controller 40. When the operator faces the loader position 34, the operator may use the second throttle controller 40, which is equipped with a pulse width modulated (PWM) sensor (not shown), to control engine speed. The ECM 24 disables operation of the first throttle controller 45. When the operator faces the backhoe position 35, the operator may use either the second throttle controller 40 or the first throttle controller 45 to control the engine speed, with the ECM 24 using the maximum speed command between the two controllers 45, 40. When the operator is in the middle facing position 36, the operator can operate the backhoe 12 with the engine speed controlled by the first throttle controller 45.

In cases where the operator transitions from the loader position 34 to the middle facing position 36 and the first throttle controller 45 is not at the low idle setting, the ECM 24 will hold the engine speed at low idle and only relinquish control when the first throttle controller 45 is set back to low idle, as indicated by steps 240 and 260.

The strategy 200 may also be integrated with an automatic engine speed control strategy. For example, if the engine is under automatic engine speed control, an operator may press the engine speed reduction-disabling switch 30 to bring the engine speed back under the command of the first throttle controller 45. In addition, the strategy 200 may also change control from the first throttle controller 45 to the second throttle controller 40 if a brake pedal (not shown) is activated. In the event of a hardware failure, the strategy 200 may also disable functionality of the first throttle controller 45, returning the engine speed command to the second throttle controller 40.

This strategy ergonomically allows the operator to use a remote throttle controller 45 during backhoe operations, while integrating the use of the first throttle controller 45 with the second throttle controller 40 during loader operations. Other aspects, objects and advantages of this disclosure can be obtained from a study of the drawings, the disclosure, and the appended claims.

What is claimed is:

1. A machine comprising:
a body;
an engine mounted within the body and powering the machine;
a seat assembly being rotatably mounted to the body and moveable between a first position and a second position;
an electronic control module in electrical communication with the engine and the seat assembly;
a first throttle in electrical communication with the electronic control module and operable to control engine speed with a first throttle command when the seat assembly is in the first position; and
a second throttle in electrical communication with the electronic control module and operable to control engine speed with a second throttle command when the seat assembly is in the second position and the second throttle command is greater than the first throttle command.

2. The machine of claim 1, wherein the first throttle is a foot pedal and the second throttle is a hand throttle.

3. The machine of claim 2, wherein the machine is a backhoe loader.

4. The machine of claim 3, wherein the seat assembly includes a middle position between the first position and the second position, and the second throttle is operable to control engine speed when the seat assembly is in the middle position.

5. A control system for use in a machine, the machine having a seat assembly moveable between a first position and a second position; comprising:
a seat assembly position sensor mounted to the seat assembly;
an electronic control module in electrical communication with the seat assembly position sensor and including an engine speed control algorithm to determine an engine speed;
a first throttle in electrical communication with the electronic control module and sending a first throttle command;
a second throttle in electrical communication with the electronic control module and sending a second throttle command; and
the engine speed control algorithm using the first throttle command to determine the engine speed when the electronic control module determines the seat assembly is in a first position, and the engine speed control module using the second throttle command to determine the engine speed when the electronic control module determines the seat assembly is in a second position and the second throttle command is greater than the first throttle command.

6. The control system of claim 5, wherein the first throttle is a foot pedal and the second throttle is a hand throttle.

7. The control system of claim 6, wherein the machine is a backhoe loader.

8. The control system of claim 7, wherein the engine speed control algorithm uses the second throttle command to determine the engine speed when the electronic control module determines the seat assembly is in a middle position between the first position and the second position.

9. A method of operating a machine, the machine having an engine, an electronic control module in electrical communication with the engine, a seat assembly in electrical communication with the electronic control module, and a first and a second throttle in electrical communication with the electronic control module, including the steps of:
operating the engine with a first throttle command from the first throttle when the seat assembly is in a first position; and
operating the engine with a second throttle command from the second throttle when the seat assembly is in a second position and the second throttle command is greater than the first throttle command.

10. The method of claim 9, including the step of:
operating the engine with the second throttle command from the second throttle when the seat assembly is in a middle position between the first position and the second position.
